(19) United States
(12) Patent Application Publication
(10) Pub. No.: US 2025/0256616 A1
(43) Pub. Date: Aug. 14, 2025

(54) Commercial-Grade Export Power System for Integration on Vehicle Platforms

(71) Applicant: Inventev LLC, Detroit, MI (US)

(72) Inventors: David J. Stenson, Novi, MI (US); Jacob N. George, Rochester Hills, MI (US)

(73) Assignee: Inventev LLC, Detroit, MI (US)

(21) Appl. No.: 19/053,681

(22) Filed: Feb. 14, 2025

Related U.S. Application Data
(60) Provisional application No. 63/553,333, filed on Feb. 14, 2024.

(51) Int. Cl. B60L 55/00; B60L 3/04; H02J 3/32

(52) U.S. Cl. CPC B60L 55/00; B60L 3/04; H02J 3/322; B60L 2210/40

(57) ABSTRACT

Disclosed herein is a mobile system for an electric vehicle including a DC power source operable alone or in concert with an engine able to generate power and/or transfer mechanical torque to drive the vehicle, an inverter in electrical communication with the power source, and an interface in electrical communication with the inverter and configured to connect a load to the vehicle system, wherein the system is configured for one directional AC power export at a commercial power magnitude. Advantageously, the systems disclosed herein can provide single directional & grid forming island power which is not grid following.

### CROSS-REFERENCE TO RELATED APPLICATIONS(S)

This application claims the benefit of priority to U.S. Provisional Patent Application No. 63/553,333 filed on Feb. 14, 2024, the disclosure of which is hereby incorporated by reference in its entirety.

### FIELD OF THE DISCLOSURE

The present disclosure generally relates to electric power export. More particularly, the present disclosure relates to systems and methods for a commercial-grade export power system for integration on work truck platforms.

### BACKGROUND OF THE DISCLOSURE

Electrified powertrains, including Hybrid electric vehicles (HEVs) are becoming more prolific in the passenger car market and therefore are continuing to expand globally. In many aspects, such HEVs combine the benefits of both internal combustion engine and battery electric vehicles. However, their use in commercial fleets, such as trucks, vans, and utility vehicles are still not completely realized. Such gaps have created opportunities for innovators interested in developing improved systems for these commercial vehicles where their architecture can provide useful utility. One of the emerging applications of such vehicles is the integration of power export systems, which enable these vehicles to provide electrical power to external devices and equipment, such as on jobsites, construction sites, agriculture, and emergency services where access to reliable power sources is critical. By leveraging the vehicle's battery capacity, the HEV can serve as a mobile power generator or energy transfer or reserve source. For example, commonly assigned U.S. Pat. Nos. 9,315,187 and 10,618,510, the contents of which are incorporated by reference in their entirety, describe a plug-in hybrid Electric Vehicle (EV) system including an ability to export power.

The demand for portable power solutions has grown significantly in recent years, driven by the increasing prevalence of remote job sites and the need for clean, quiet, and efficient energy sources. Power export systems can address this need by allowing PHEVs to supply electricity for tools, lighting, and other equipment directly at the job site, minimizing downtime and maximizing productivity. Despite the potential benefits of power export systems in plug-in hybrid vehicles (PHEVs), significant limitations exist due to the current state of technology, particularly concerning power output levels. Many existing power export systems are designed to provide low to moderate power levels, which may not meet the demands of various applications at job sites, particularly at professional or commercial grade versus retail customer personal use. For instance, heavy-duty construction equipment and high-powered tools often require more substantial power outputs than what standard PHEV systems can deliver or are based on supplying energy as part of a fixed infrastructure bi-directional EVSE/charger energy system requiring pre-installed wiring, supplemental battery storage and often centralized energy management at a private residence or other facility. This limitation restricts the versatility of PHEVs as mobile power sources, rendering them less effective for industries that rely on mobility and high-capacity energy for operations. As such, there exists a need in the state of the art for methods and devices to provide mobile grid “island” power at magnitudes greater than what currently exists.

### BRIEF SUMMARY OF THE DISCLOSURE

The present disclosure relates to systems and methods for a commercial-grade export power system for integration on work truck platforms. More specifically, the present disclosure relates to a commercial-grade export power system for integration on work truck platforms. This is not dependent on Electric Vehicle Service Equipment (EVSE) (sometimes referred to as a bi-directional charger) nor pre-installed infrastructure at power point-of-use. This will provide an EV-based grid-forming AC power supply similar to today's diesel generator set capabilities up to 75 kW. Advantageously, the methods and devices disclosed herein can enhance the utility of work vehicles, enabling them to serve as reliable mobile power sources for various applications. More specifically, an advantage of the methods and devices of the present disclosure includes the ability to provide high power magnitude, grid forming island power from a commercial vehicle.

The disclose generally provides a power export system including a panel mounted on the side of the truck configured to be coupled with standard electrical loads. An inverter can be disposed subjacent to a vehicle proximal to a high voltage power supply. Such an arrangement can allow for easier access and maintenance of the operator controls and external connecting interface while maximizing power density of the energy conversion function where the vehicle high-voltage DC power and liquid cooling circuits reside. Further, the system can be configured for flexibility making it suitable for on-grid and off-grid scenarios, which can be particularly useful for remote locations where traditional power sources are unavailable.

Additionally, the power export system can include one or more safety features and accessible user controls. For example the power export system can include both power inverting electronics and user control systems which can be distributed through the system, and more generally, the vehicle, thereby enhancing both electrical efficiency and thermal management. The power export system can include an external human-machine interface (HMI) which can allow for convenient access and control by a user. In various aspects, the power export system can be controlled remotely for example via Wi-Fi or mobile applications.

In one aspect, disclosed is a vehicle system for an electric vehicle including a DC power source operable to drive the vehicle, an inverter in electrical communication with the power source, and an interface in electrical communication with the inverter and configured to connect a load to the vehicle system, wherein the system is configured for one directional AC power export at a commercial power magnitude.

In another aspect, disclosed is a vehicle system for a hybrid vehicle including a primary mover (i.e., a generic for engine), a secondary mover (i.e., a motor/generator), DC power source operable to drive the vehicle or generate additional power, an inverter in electrical communication with the power source, and an interface in electrical communication with the inverter and configured to connect a load to the vehicle system, wherein the system is configured for one directional AC power export at a commercial power magnitude.

In yet another aspect, disclosed is a method of controlling off-grid power export from a vehicle or other mobile unit (i.e., a trailer or any structure separate which can be towed or moved by a main vehicle), including signaling to a battery via a battery control unit to provide one directional DC power to an inverter, transforming the DC power to AC power, and exporting in a single direction the AC power to a user via an interface, wherein the signaling, transforming, and exporting are controlled via a control unit disposed in the interface.

### BRIEF DESCRIPTION OF THE DRAWINGS

The present disclosure is detailed through various drawings, where like components or steps are indicated by identical reference numbers for clarity and consistency.

FIG. 1 is a schematic view of a vehicle equipped with a power export system in accordance with one aspect of the present disclosure.

FIG. 2 is a schematic view of an inverter in-line with a power source of the power export system of FIG. 1 in accordance with another aspect of the present disclosure.

FIG. 3 is a frontal perspective view of the inverter of FIG. 2 of the power export system of FIG. 1 in continuing accordance with an aspect of the present disclosure.

FIG. 4 is a frontal perspective view of an interface of the power export system of FIG. 1 in further continuing accordance with one aspect of the present disclosure.

FIG. 5 is an alternative perspective view of the interface of FIG. 4 in accordance with the aspect of the present disclosure.

FIG. 6 is an operational diagram of an exemplary operation of the power export system in accordance with an alternative aspect of the present disclosure.

### DETAILED DESCRIPTION OF THE DISCLOSURE

Again, the present disclosure generally relates to methods and devices for a commercial grade export power system for integration on work truck platforms. The export power system can be configured to integrate with hybrid vehicle platforms, for example vehicle models intended for fleet or industrial use. In many aspects, the export power system can be configured to provide a power output of about 75 KW. More generally, the export power system can provide commercial-level power. Such power levels significantly exceed the power export capacity of current fleet vehicles. These power levels are particularly advantageous for commercial users, for example on construction sites or other remote, off-grid, or in emergency duty with local grid disruption. Notably, the power export system disclosed herein can exclude the capacity for bi-directional charging (via EVSE). As such, the system can be used in any location by connecting directly to buildings, power infrastructure, or singular devices or form micro-grids. In some aspects, the device and methods can include a power connector disposed on a side of the work vehicle which can include one or more power connectors for split single phase or 3-phase power distribution. It is envisioned that the device can include a substantially user-friendly interface.

One advantage of the device and methods of the disclosure is the ability to support off-grid applications, remote locations, and emergency backup power. This can be accomplished at least by the high magnitude of power output and via split phase or 3-phase power output. The system and device can include a human-machine interface (HMI) disposed on the inverter or control panel. It is envisioned that the systems and methods of the present disclosure can be incorporated into new vehicles during construction. In other aspects, the systems and methods can be retrofitted onto existing fleet vehicles.

Additionally, the systems and devices of the present disclosure can provide high magnitude split phase power to remote locations, and more generally can provide emergency backup power. The devices disclosed herein include a more efficient distribution of hardware items about the fleet vehicle enabling smaller, more compact individual system elements. Other components or functions, including the power converter, controller, safety shut off, and user interfaces can be disposed about the vehicle, for example on the exterior for ease of access and remote operation.

### Definitions

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used). Unless defined otherwise, all technical and scientific terms used herein have the same meaning as commonly understood by one of ordinary skill in the art to which this invention pertains.

As used herein, the term Vehicle to Grid (V2G) generally refers to a grid present/grid following power scheme where electric vehicles (EVs) can interact with the electrical grid via bidirectional energy flow. More generally, V2G enables an EV to both draw from and send back stored or generated electrical energy. The connection requires a phase alignment of alternating current (AC) power sine wave form to the local utility grid.

As used herein, the term′ Vehicle to Load” (V2L) generally refers to a power transfer scheme wherein an EV is supplying power to external electrical devices with no other connection to buildings or the local utility grid (e.g. power tools).

As used herein, the term “Export Power Panel” (EPP) generally refers to an interface device configured to access export power from a power supplying source.

As used herein, the term “Vehicle to Home” (V2H) generally refers to grid absent/local grid forming power schemes. More generally, V2H enables an EV to form a local or temporary power grid for a building decoupled from the main local utility grid by means of a transfer switch or similar.

As used herein, the term “Electric Vehicle Supply Equipment” (ESVE) generally refers to equipment used to deliver electrical energy from a source to charge an EV or to and from an EV in the case of a bi-directional EVSE to both charge and receive stored or generated power from the EV.

### System Architecture

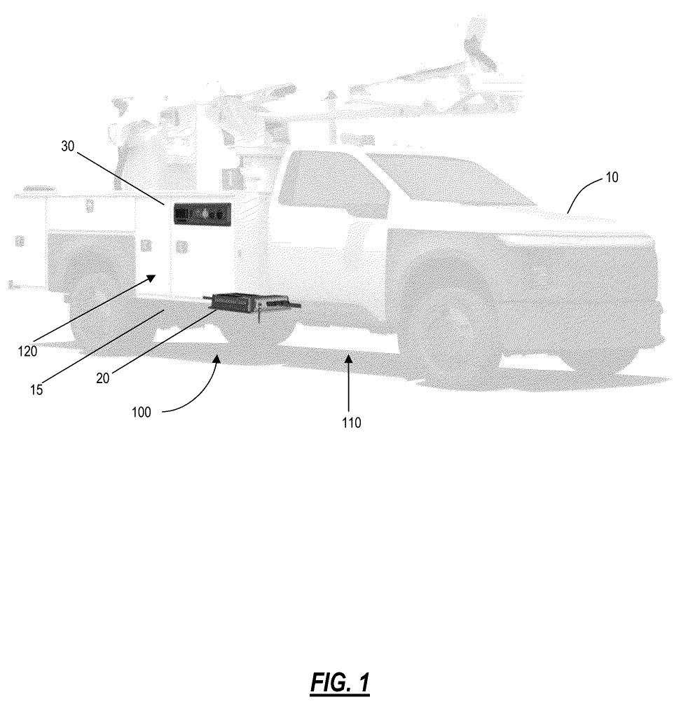

Turning now to FIG. 1, a schematic view of a vehicle 10 equipped with a power export system 100 is shown and described. In some aspects the vehicle 10 can be a fuel cell electric vehicle or a hybrid electric vehicle, wherein the vehicle 10 may be configured to convert power from two sources, for example an internal combustion engine and a DC battery/High Voltage Power Distribution Unit (battery/HVPDU) 15 coupled with an electric motor. If an internal combustion engine of the vehicle 10 is present it can be configured to utilize gasoline, diesel, natural gas, or any alternative fuel configured for use within an internal combustion engine. Further in the aspect where an engine is present the vehicle 10 can be a series hybrid, a parallel hybrid or an electric vehicle with range extender through generating power onboard. The vehicle 10 can be configured to receive and store electrical power, for example by plugging into the grid or by generating power via the internal combustion engine or hydrogen fuel cell or other energy conversion technology. This on-vehicle energy source may consist of one or more sub-components such as a battery/HVPDU 15 cell, modules, bank of batteries, ultra-capacitors or similar and may include its own control and monitoring system, such as a battery management system (BMS). The vehicle 10 can include one or more electric machines configured to function as both a motor(s) (i.e., torque-generating) and as a driven generator(s) directly from an engine or through absorbing kinetic energy such as in regenerative braking (producing electrical power). These may be permanent magnet three-phase AC motors or induction motors commonly specified as generators or traction motors for automotive use. An exemplary embodiment may have a first prime mover, a second prime mover and a third prime mover with a similar or identical peak torque output in the 300 Newton-meter range and a continuous power rating in the 80 kilowatt range with a nominal operating voltage of 320 volts. In some aspects, the vehicle 10 can be a pure EV or battery electric vehicle. As such, the vehicle will be configured to be motivated solely by an electric motor.

The vehicle 10 can include a power storage device, such as a battery/HVPDU 15 or capacitor. The vehicle 10 can include a rechargeable battery/HVPDU 15, such as and without limitation a nickel-metal hydride (NiMH), a lead acid battery/HVPDU 15, Lithium Nickel Manganese Cobalt oxides (Li-NMC), Lithium Iron Phosphate (LFP), Lithium Titanate (LTO), Sodium-Ion, Nickel Cadmium (Ni-Cad), or a Lithium-Ion (Li-Ion) or solid state battery. The battery/HVPDU 15 can be configured to assist the internal combustion engine during acceleration in a hybrid electric vehicle or plug-in hybrid electric vehicle, power the vehicle in an electric only mode such as in a battery electric vehicle, and enable regenerative braking wherein the traction motor(s) functions as a generator with deceleration intent and converts the kinetic energy of the vehicle into electrical energy. The battery/HVPDU 15 can be without limitation between 10 kWh to 500 kWh or more storage capacity. In some aspects, the vehicle 10 can include an alternative power source, such as a hydrogen fuel cell configured to provide electrical power to the vehicle 10 and/or battery/HVPDU 15. Such batteries can provide DC power in excess of 800 Volts.

In some aspects, the vehicle 10 can be a commercial vehicle or a marine vessel. For example, the commercial vehicle 10 can be used primarily for the transportation of goods, passengers or used for services in the course of business or commercial activity. For example, the vehicle 10 can be a van, a pickup truck, a delivery truck, a box truck, a bus, a tractor trailer, a tanker truck, a dump truck, a fire truck, a tow truck, a bucket truck, a service truck, a tug boat, ferry boat, service vessel or the like. The vehicle 10 can be a fleet vehicle 10, wherein the fleet vehicle 10 is associated with a business or industry. The vehicle 10 can be an industrial vehicle 10 configured for use on a job site, a construction site, a power line site, an industrial setting, an agriculture setting, or the like. In other aspects, the vehicle can be a piece of equipment, such as a tractor, a loader, a forklift, or any off highway vehicle or maritime vessel equipped with a battery or hybrid drive system.

The power export system 100 can be configured to be coupled with the vehicle 10 when the vehicle 10 is being assembled. In other aspects, the power export system 100 can be configured to be retrofitted to existing vehicles 10. Some components of the power export system 100 can be mounted on an underbody 110 location of the vehicle. Such underbody packaging typically is shielded from debris and other objects and enables a more efficient integration close to high-voltage DC connections and liquid cooling circuits. In general aspects, the power export system 100 can be configured to interact with the battery/HVPDU 15 of the vehicle 10, which is typically disposed on an underbody location thereof. The power export system 100 can include an inverter (PCU) 20 and an interface 30. The PCU 20 can be disposed on the underbody 110 of the vehicle 10. The interface 30 can be disposed on the side 120 of the vehicle 10. In typical aspects, the interface 30 and the PCU 20 can be in electrical communication with the battery/HVPDU 15 and control system of the vehicle 10.

In general aspects, the power export system (PES) 100 can be configured to provide electrical power to an external source. For example, the PES 100 can be configured to provide power to a jobsite or construction site. In analogy, the PES 100 can supply power similar to an internal combustion engine, often diesel-powered, backup generator. The uses of such power supplying device are vast, as there exists a constant need for off-grid power, for example and without limitation, at rural worksites, during storms or power outages, at commercial worksites where access to the grid is limited, etc. Importantly, the PES 100 can access the battery/HVPDU 15 of the vehicle and export the electrical power to the outside loads. Advantageously, the PES 100 can be configured to be a one-directional power supply. More specifically, the PES 100 is configured to not provide power to the grid; the PES 100 is operable to only receive power from an operating grid while in communication therewith. The PES 100 is not dependent on a bi-directional charger or a pre-installed infrastructure. Moreover the PES 100 is configured to provide grid-forming power. The PES 100 can be configured to provide grid-forming power at point-of-use. Again, the PES 100 is structured to only provide power export at point-of-use and not to the grid. Such configurations allow the PES 100 to function as an island power supply. The PES 100 can be a decentralized power generation system which is independent from the main electrical grid. Advantageously, the PES 100 can function in remote locations, temporary worksites, or during emergencies when connection to the grid is not feasible. Again, because the PES 100 does not use a bi-directional charger, it can be used anywhere with simple and temporary connectors to the load.

The PES 100 is of particular advantage because of its resilience through independence of the central grid. As such, the PES 100 can remain operable during complete failure of the grid. Further, because the PES 100 is adapted onto fleet vehicles 10, it is exceptionally mobile when compared to larger hardware, such as large, bulky, and cumbersome internal combustion powered generators typically mounted on separate trailers for this scale of power output. In addition, the PES 100 can be more scalable when compared to existing grid solutions. For example the PES 100 can be used at a small construction site where a small gasoline powered generator is suitable as well as a somewhat larger facility where a higher power magnitude is needed but not to the scale of high-capacity industrial power.

Advantageously, the PES 100 can be operable to provide commercial power. In particular, the PES 100 can be adapted to provide a power output of about 75 KW. More generally, the PES can be configured to provide a power magnitude of about 50 to 200 KW and may have special configurations for parallel power conversion modules for scalability. Such power magnitude far exceeds the state of the art power supplies configured for vehicles. Commercial power, such as that provided by the PES 100, can be used for small to medium sized business, jobsites, or industrial operations where the specific applications require a reliable and consistent power supply. In typical aspects, the PES 100 can provide up to 75 KW which is sufficient electricity to support various loads, such as HVAC systems, lighting, light machinery, computers, and other essential equipment within a small commercial space. Notably, the state of the art tends to rely on small batteries or alternators which provide direct power export at a substantially lower power magnitude (typically only sufficient to operate a few lights or handheld tools); or, provide DC power through a bi-directional EVSE into a permanent infrastructure energy management system such as for residential home power backup. The PES 100 can provide power at a magnitude sufficient to handle a greater variety of loads simultaneously, making it ideal for off-grid applications with more extensive power demands.

The PES 100 can provide a higher power quality than a typical generator because it receives power from a constant DC voltage supply rather than an internal combustion engine. As a result, the power fluctuations are lower. The PES 100 can be operable to provide 120/240V split single-phase power. More specifically, the PES 100 can be a power supply having two hot wires and a neutral wire, wherein the voltage between the hot wires is double the voltage to neutral wire. The PES 100 can also be implemented to provide multi-phase power. At higher power requirements, multi-phase power is often required. The PES 100 can provide three-phase power, defined by three alternating currents offset by 120 degrees. Such configuration is more suitable for commercial and industrial uses where constant power is required. As such, the PES 100 can deliver more power through smaller conductors and reduce space requirements.

Again, the PES 100 can provide a power magnitude of up to about 75 KW, which far exceeds the current vehicle AC export power capabilities. Further, such power magnitude is ideal for commercial customers, such as a utilities or construction. The PES 100 can be island micro-grid forming and substantially mobile when compared to other systems as a result of being incorporated directly to the vehicle 10. Because the PES 100 is not tied to an EVSE, it can provide a customer with AC power from anywhere. Of note, in hybrid vehicle applications, the vehicle 10 can be operable to supply electrical power to the battery/HVPDU 15 and thus the PES 100, further increasing the separation of the PES 100 from the grid. The approach possible with the devices and methods disclosed herein are especially useful for off-grid (remote) locations or for emergency backup power, for example, at a 120/240V split single phase (residential) circuit level.

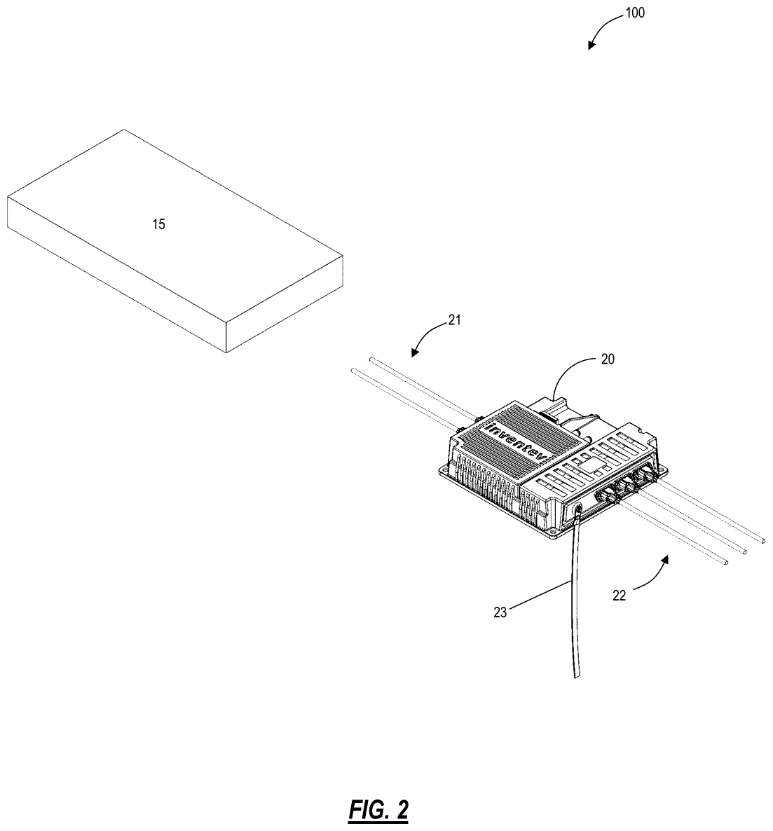

Turning now to FIG. 2, a schematic view of the inverter 20 in-line with the battery/HVPDU 15 of the PES 100 of FIG. 1 is shown and described. The inverter 20 can be in electrical communication with the battery/HVPDU 15 via a first connection 21. The first connection 21 can be a positive and negative connection configured to provide the inverter 20 with DC power from the battery/HVPDU 15. More generally, the inverter 20 can be configured to receive power from a power supply, which can be provided by the battery/HVPDU 15, an alternator, a fuel cell, or the like. Importantly, the inverter 20 does not receive power from or share a connection with the grid. The inverter 20 can include a second connection 22. The second connection 22 can be configured to provide AC electrical power output from the inverter 20 to the interface 30 for eventual export from vehicle 10. In some aspects, the second connection 22 can define a wiring configuration suitable for three phase or split phase power. The inverter 20 can include a third connection 23. The third connection 23 can be configured to ground the inverter 20 and can be electrically coupled with the vehicle 10, for example via the frame, to an earth grounding rod or equivalent external to vehicle 10, and connect and ground the inverter 20 to the interface 30.

The PES 100, and more specifically the inverter 20 can be configured to convert the DC power from the battery/HVPDU 15 to AC power. Importantly, AC power is required as most external loads and power requirements are AC. The inverter 20 can include a variable frequency drive (VFD) and can be configured to modulate any of a frequency, voltage, and power of the AC power output. The inverter 20 can be configured for battery management wherein the inverter manages the voltage of the battery/HVPDU 15. In some aspects, the inverter can include an integrated battery management system (BMS) which can monitor the battery health, state of charge, temperature, and other parameters. Notably, the inverter 20 is not configured to V2G power flow.

Notably, the inverter 20 can be disposed on the underbody 110 of the vehicle 10 proximal to the battery/HVPDU 15. It is envisioned that the inverter 20 is disposed as close to the battery/HVPDU 15 on the underbody 110 of the vehicle 10 as possible. In a first aspect, by way of situating the inverter 20 close to the battery/HVPDU 15, the wiring and cooling circuit efficiency increases. Through such arrangement, the first connection 21 can be shortened. The shorter distance between the battery/HVPDU 15 and the inverter 20 reduces the length of electrical cables of the first connection 21 and can reduce the cost and voltage drop. By reducing voltage drop, the inverter 20 can operate more efficiently. In addition, a closer inverter 20 can react more quickly to changes in power demand providing immediate power to the load and other components. Moreover, shorter first connection 21 cables can help maintain the integrity of the power signal, resulting in more stable voltage and frequency for the connected systems. The inverter's proximity to the load can permit quick reactions to changes in power demand; with shorter first connection cables, the integrity of the power signal is maintained, resulting in more stable voltage and frequency for connected systems. This configuration minimizes transmission time and power loss. This is because the shorter distance reduces the transmission time required for the power to travel from the inverter to the load. The inverter can adjust its output responsive to fluctuating power demands. A closer inverter can detect and respond to these changes more rapidly, ensuring that the load receives the necessary power almost immediately. Over longer distances, electrical signals can degrade due to the resistance and inductance of the cables. Resistance causes energy to be lost in the form of heat, while inductance can cause delays and distortions in the signal. By using shorter cables, these effects are minimized, resulting in a more stable and consistent power signal. This stability is essential for maintaining the proper voltage and frequency needed for the connected systems to function correctly.

Again, the power inverting electronics of the PES 100 and sub-systems can be placed on the underbody 110 of the vehicle 10 or closer to the DC power source (i.e., the battery/HVPDU 15) for optimal electrical, cooling, and packaging efficiency.

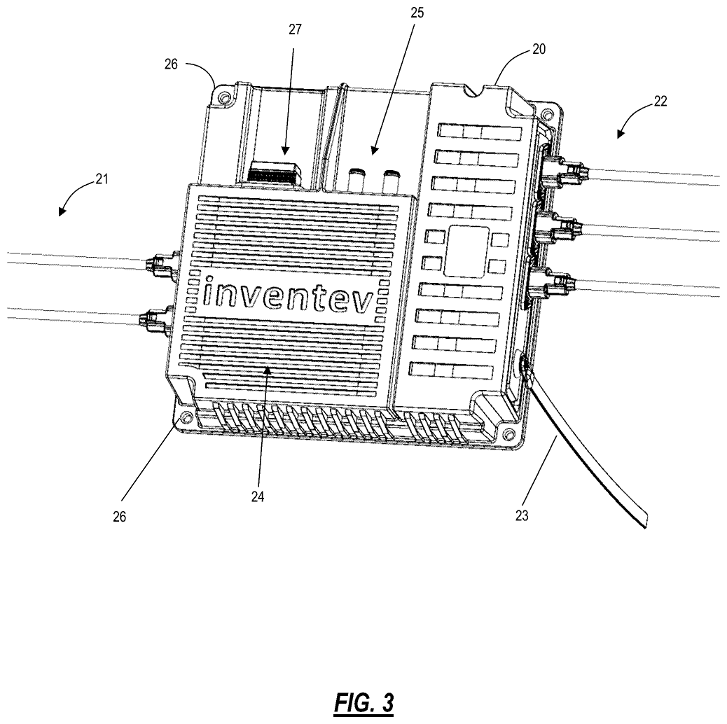

Turning now to FIG. 3, a frontal perspective view of the inverter 20 of FIG. 2 is shown and described. The inverter 20 can include a cooling system. The cooling system can be an IC cooling technology system which is operable to reduce the size of the inverter by 50%. The inverter 20 can include passive cooling, such as a heat sink 24 and natural convection conducive architecture as well as passive cooling such as fans or liquid cooling fed by a liquid cooling port 25. The liquid cooling ports 25 can be a barbed fitting, a push-lock fitting, a quick connect fitting, a hose barb elbow fitting, a compression fitting, a flare fitting, a swivel fitting, an Army-Navy fitting, or the like. In some aspects, the inverter 20 can operate with a combination of passive and active cooling systems. More generally, the inverter 20 can include a system to manage heat produced during the power conversion. The incorporation of such cooling technologies can reduce the size and mass of the inverter 20.

The inverter 20 can include one or more fastener tabs 26. The fastener tabs 26 can be disposed about the body of the inverter. The fastener tabs 26 can be a substantially flat portion which can define a hollow through hole configured to receive a fastener. It is envisioned that the fastener tabs 26 can be used to fasten the inverter 20 to the vehicle 10. In some aspects, the inverter 20 can include 4 fastener tabs 26 disposed in each corner of the inverter 20. In some aspects, the inverter 20 can include a port 27. The port 27 can be structured to connect a digital device to the inverter, such as a controller or diagnostics tool. The port 27 can be a multi-pin connector configured for control signal and communication interface. More generally the port 27 can be used to transmit data, control signals, or power between the inverter and an external controller or other device. The port 27 can be a CAN-Bus connector, a RS-485 or RS-232 connector, a D-Sub (DB9/DB15) connector, or a proprietary connector.

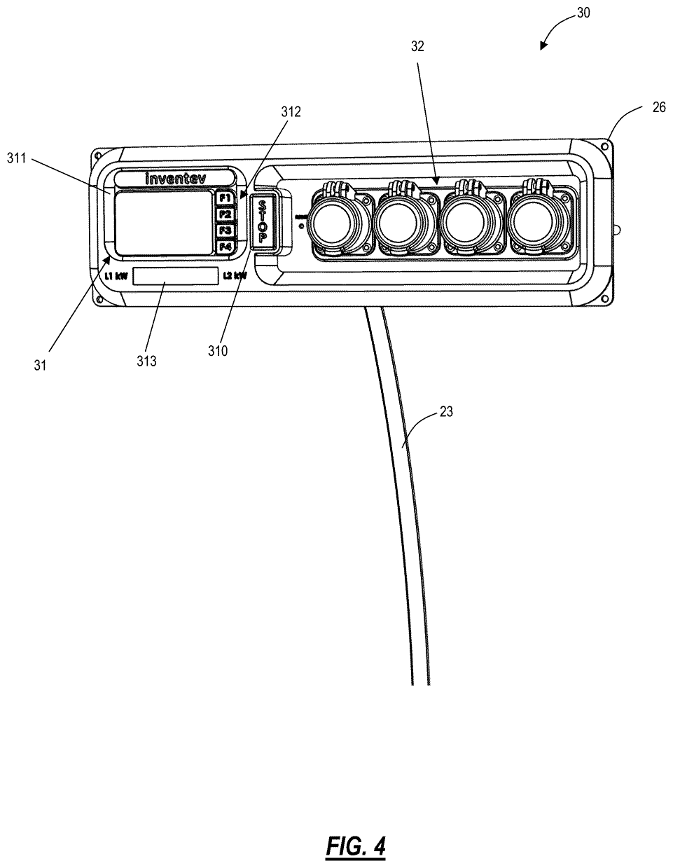

Turning now to FIG. 4, a frontal perspective view of the interface 30 of the power export system 100 of FIG. 1 is shown and described. The interface 30 can be in electrical communication with the inverter 20. In general, the interface 20 can be configured to interact with an operator that is operable to control the inverter 20. The power inverting electronics and controller of the PES 100 are separated and distributed for system optimization. As such, the inverter 20 is disposed on the underbody 110 of the vehicle and the interface 30 is disposed on a side 120 portion of the vehicle 10. It is envisioned that the interface 30 is disposed on a side 120 of the vehicle 10 which is easily accessible and ergonomic.

The interface 30 can include one or more controls 31 such as a switch, safety software, emergency shut-offs 310, a human-machine-interface (HMI) 311, controls 312, remote access (i.e., Wi-Fi or mobile phones), gages 313 and instrumentation, system status indicators, or the like. The controls 31 can be one or more switches. The switches can provide manual control over the inverter's operation. For example the switch can be an on/off switch or a more complex toggle switch to toggle between different operating modes. The switches can be configured such that a user can quickly enable or disable the inverter 20 or switch between modes manually. The controls 31 can include safety software. The safety software can monitor the inverter's 20 operation and ensure that it is operating within safe parameters. The safety software can consider the load, the battery/HVPDU 15 health, and other operation parameters. The safety software can, for example and without limitation, monitor for overcurrent, thermal overload, and fault detection. If the safety software detects unsafe conditions (i.e., excess heat or short circuits), the safety software can trigger protective measures such as reducing power output or shutting down the inverter to prevent damage or hazards.

The controls 31 can include an emergency shut offs 310. The emergency shut off 310 can be manual or automatic controls that are operable for the immediate disconnection of the inverter 20 in case of emergencies, such as overheating, overcurrent, electrical faults, or other system failures. Importantly, the emergency shut-off 310 is critical for safety and is operable for quick deactivation of the PES 100. The controls 31 can include the HMI 311. The HMI 311 can be configured for a user interface for operators to interact with the PES 100. For example, the HMI 311 can include a display screen, one or more HMI controls, and a speaker which can collectively allow operators to control, interact, and monitor the PES 100 function. In example, operators can adjust setting, view real time data (e.g., voltage, current, power output, etc.) and access alarms or diagnostic information through the HMI 311. In some aspects, one or more attributes of the PES 100 can be programmable via the HMI 311. In some aspects, the interface 30 can include remote access. For example, the interface 30 can be controlled over Wi-Fi, Bluetooth, or through a mobile phone app. In some aspects, the interface 30 can be controlled via a mobile network, an app, or a web interface on a smartphone, tablet, or computer. Notably, the remote access can allow an operator to monitor the PES 100 status, make adjustments, receive alerts, or perform diagnostics without being physically near the system. This is particularly useful in large installations or when the PES 100 is located in remote or difficult to access areas.

The interface 30 can include one or more gages 313. The gages 313 can be any instrumentation to provide feedback, such as visual feedback to users. The gages 313 can be digital or analog and can be on a forward face of the interface 30. In some aspects, the gages 313 can be configured to display to the operator any of, without limitation, voltage, power output, temperature, battery charge level, or the like. The gages 313 can display real-time data and can track PES 100 conditions and provide for the operator to make adjustments. The controls 31 can be arranged as a panel on the interface 30.

The PES 100 can provide a better human interface with the inverter 20 as well as improved efficiency of component location. This also enables untethered/wireless access for emergency backup situations. This is optimal for new energy vehicles with are enabled to provide quick and easy ways to enable the export of power, especially in emergency situations where electrical power from the grid has been loss. It is also essential in enforcing a process that optimizes safety considerations for dealing with high voltage DC and high current AC power to the external load. The HMI 311 systems and software controllers can create lockouts and test for and prevent grounding issues during operation.

The interface 30 can include one or more load connectors 32. The load connectors 32 can be any electrical connection suitable for high power transmission, such as a cam-style locking connector, a NEMA connector, an Anderson Powerpole connector, an IEC connector, a Twist-Lock connector, a power distribution Unit (PDU) and breakout box, a Pin & Sleeve Connector, a MC4 connector, a Ring Terminal and Lug Connector, or the like. The load connectors 32 can be a single pole connector configured for high-current and temporary electrical distribution system use. The load connectors 32 can be configured to be securely releasable by “fitting” or “twisting” the load connectors 32 together to mechanically engage the load connectors 32 and provide electrical communication between the PES 100 and the electrical load. It is envisioned that the interface 30 can include a plurality of load connectors 32 in numbers consistent with type of power exported such as split single phase versus 3-phase AC power versus lower-voltage DC power.

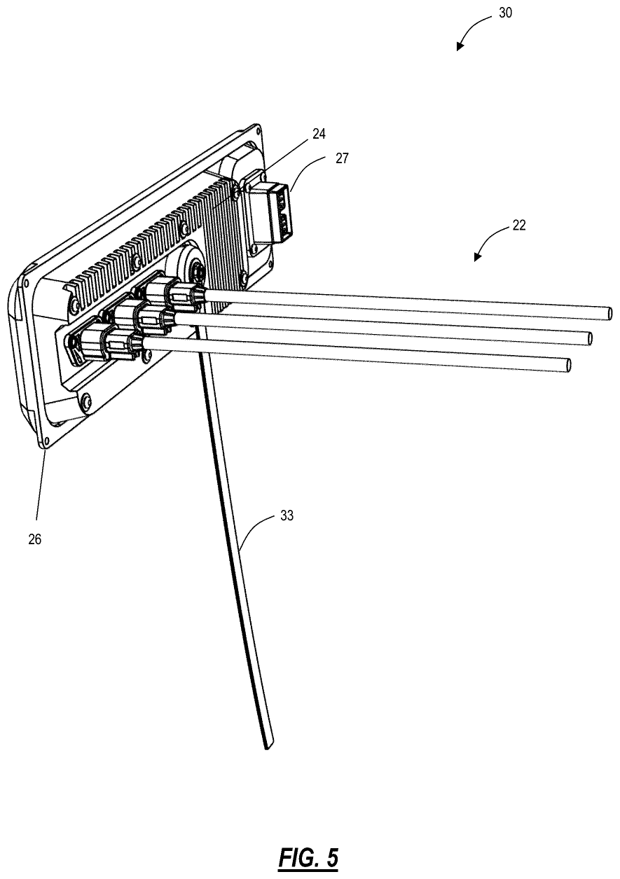

Turning now to FIG. 5, an alternative perspective view of the interface 30 of FIG. 4 is shown and described. The interface 30 can receive the second connection 22 and third connection 23 from the inverter 20. The interface 30 can therefore be in electrical communication with the inverter 20. The second connection 23 can be configured to provide the power output to the electrical load. The fastener holes 26 can be disposed about the perimeter of the interface 30 and can be configured to receive a fastener which secures the interface 30 to a side 120 portion of the vehicle 10. The interface 30 can include cooling fins 24 on a back portion thereof configured to remove heat therefrom. In example, the interface 30 can include a plurality of fins 24 distal to the interface 31 and configured to remove heat therefrom. The interface 30 can include a port 27. The port 27 can be configured to provide communication between the interface 30 and inverter 20 and low voltage power and communication with vehicle 10 control network such as CAN network.

### Method of External Power Supply

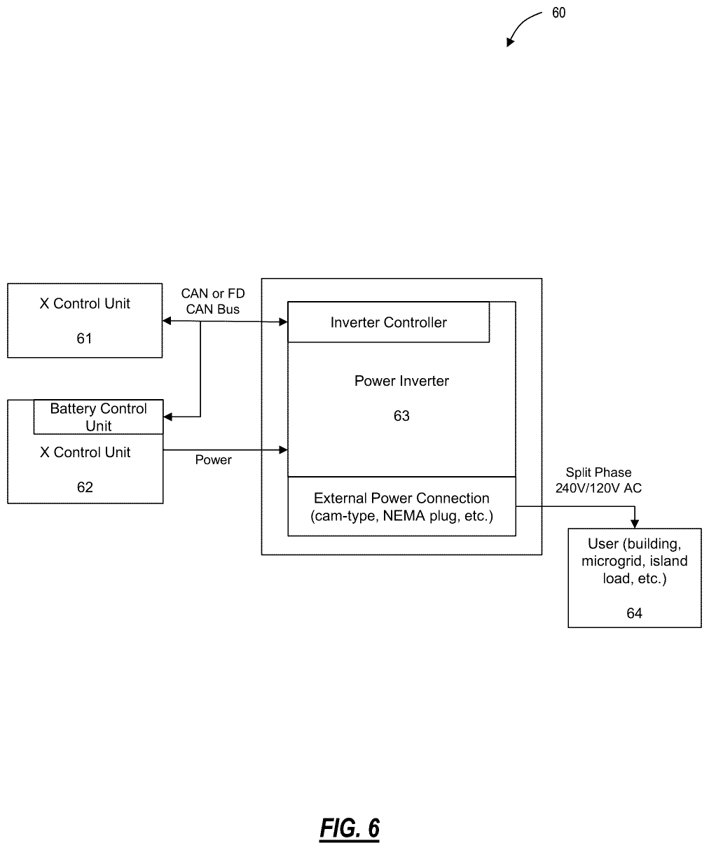

Turning now to FIG. 6, an operational diagram of an exemplary operation 60 of the power export system 100 is shown and described. The operation 60 of the PES 100 can generally be configured to provide commercial grade one-directional power to a building, jobsite, etc. The operation 60 includes a control unit 61 which can be disposed in the interface 30 and can be in communication with a battery control unit 32 disposed in the battery/HVPDU 15 and an inverter control unit 63 which can be disposed in the inverter 20. The interface control unit, battery control unit 62, and inverter control unit 63 can each be in controlling connection with the interface 30, battery/HVPDU 15, and inverter 20 respectively. The battery control unit 62 may be integral to battery/HVPDU 15 or a function within other control components of vehicle 10 and can be configured to facilitate the battery/HVPDU 15 in providing electrical power to the power inverter 20. From there, the PES 100 and more specifically the interface 30 via the load connectors 32 can provide electrical power to a user 64, such as a school worksite, building, etc. The power inverter 20 can provide split phase 240V/120V AC power or other types of power to the user 64.

The interface control unit 61 can be coupled to one or both of the battery control unit 62 and the inverter control unit 63. As such, the interface control unit 61 can be configured to coordinate the operation of the PES 100 via the control of the battery control unit 62 and inverter control unit 63, and thus the battery/HVPDU 15 and the inverter 20. Notably, the connection between the battery/HVPDU 15 and power inverter 20 is one-directional, wherein power can only flow from the battery/HVPDU 15 to the inverter 20. Similarly, the connection between the inverter 20 and the user 64 or load is likewise one directional wherein power can only flow from the inverter 20 to the user 64 or electrical load. As such, the PES 100 does not facilitate bi-directional power supply. The inverter control unit 61 can be operable for separate bi-directional control between the battery control unit 62 and the inverter control unit 63. More specifically, there can be bidirectional communication between the battery control unit 62 and the inverter control unit 61 and between the inverter control unit 61 and the inverter control unit 63.

The PES 100 can require the synchronization of the control units. The control units are responsible for coordinating the interaction between the primary components and ensure that electrical energy is delivered to the inverter 20, where it is converted into split-phase 240V/120V electrical power suitable for the user 64. Again, the PES 100 operates with a one-way power flow, where electrical power can only move from the battery/HVPDU 15 to the inverter 20, and from the inverter 20 to the user 64. This unidirectional architecture does not include provisions for returning power to the grid, but instead forming an island grid.

Disclosed is a non-limiting example of the power export system 100 being deployed. The PES 100 can be configured to provide three-phase or split-phase power at a target power magnitude of 75 KW to the user 64. The PES 100 is configured to sit between the power grid and the user 64. Further, it can be adapted onto existing vehicles 10 or new vehicles 10. Of note, the PES 100 can be configured to provide power to much more than handheld power tools and is readily available to power commercial infrastructure and jobsites with significantly higher power demands. Thus the PES 100 can be adapted for “island load” power delivery in commercial spaces. In some aspects, the PES 100 provides one-directional power flow to the user 64 and is not operable to facilitate bi-directional power flow. The PES 100 can be grid forming and essentially can be deployable power infrastructure on an as-needed basis.

One aspect of the present disclosure pertains to vehicle system for an electric vehicle (EV) including a DC power source operable to drive the vehicle, an inverter in electrical communication with the power source; and an interface in electrical communication with the inverter and configured to connect a load to the vehicle system, wherein the system is configured for one directional AC power export at a commercial power magnitude. The system can include wherein the DC power source is one of: pre-stored energy in a battery, real-time generation from an engine or generation from a hydrogen fuel cell or other energy storing or on-vehicle energy transforming process. The system can include wherein the commercial power magnitude is in the range of about 50 KW to about 500 KW. The system can include wherein the commercial power magnitude is about 75 kW. The system can include wherein the interface comprises at least one cam-type locking connector or similar for split single-phase or other export power types and a user interface configured to control the vehicle system.

In some aspects, the system can include wherein the power converter is liquid cooled. The system can include wherein the system is configured to form an island grid or single load. The system can include wherein the interface further comprises a human-machine interface, controls for remote access, safety software, and a safety shutoff. The system can include wherein the inverter is disposed proximal to the DC power source on the vehicle. The system can include wherein the power interface is disposed on an exterior surface of the vehicle.

Another aspect of the present disclosure pertains to a vehicle system for a hybrid vehicle including a DC power source operable to drive the vehicle, an inverter in electrical communication with the power source, and an interface in electrical communication with the inverter and configured to connect a load to the vehicle system, wherein the system is configured for one directional AC or DC power export at a commercial power magnitude. The system can include wherein the DC power source is one of: a battery, a series hybrid powertrain, a parallel hybrid powertrain, an EV range-extending engine-generator system or a hydrogen fuel cell. The system can include wherein the commercial power magnitude is about 75 KW. The system can include wherein the interface comprises at least one cam-style locking connector for export power and a user interface configured to control the elements of the vehicle system required to generate or provide power to the inverter. The system can include wherein the interface further comprises a human-machine interface, controls for remote access, safety software, and a safety shutoff. The system can include wherein the inverter is disposed proximal to the DC power source on the vehicle. The system can include wherein the interface is disposed on a side 120 portion of the vehicle. The method can include wherein the vehicle is one of a battery electric vehicle (EV) or a hybrid electric vehicle (HEV) a plug-in hybrid electric vehicle (PHEV) or a range-extended EV or a fuel-cell enabled EV. The method can include wherein the vehicle is one of a commercial fleet vehicle, a work vehicle or an industrial vehicle, an off highway vehicle, a marine vessel, a non-self-propelling trailer or cart or a piece of equipment.

Another aspect of the instant disclosure pertains to a method of controlling off-grid power export from a vehicle, including signaling to a battery via a battery control unit to provide one directional DC power to an inverter, transforming the DC power to AC power or lower-voltage DC power; and exporting in a single direction the AC or DC power to a user via an interface, wherein the signaling, transforming, and exporting are controlled via a control unit disposed in the interface. The method can include wherein the control unit is controlled externally by an operator. The method can include wherein the DC power is transformed into one of split phase AC power, three-phase AC power or DC power. The method can include wherein the power is provided at a magnitude of about 75 kW. The method can include wherein the power is not provided to the power grid. (see comment). The method can include wherein the power export forms an island grid. The method can include wherein the control unit is communicatively coupled to both the power source and the inverter. The method can include wherein the power is exported at split single phase 120V/240V voltage typical in residential areas but not exclusive to residential use, 3-phase power in light commercial setting and lower voltage DC power for direct loads or microgrid arrangements.

### CONCLUSION

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing might be beneficial. Furthermore, the separation of system components described should not be interpreted as mandatory for all implementations, as the program components and systems can be integrated into a single software product or distributed across multiple software products.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

What is claimed is:

1. A vehicle system for a power export comprising:
a power source configured to drive the vehicle;
an inverter in electrical communication with the power source; and
an interface in electrical communication with the inverter and power source and configured to connect a load to the vehicle system;
wherein the system is configured for one directional AC power export at a commercial power magnitude.

2. The vehicle system of claim 1, wherein the power source is one of: a battery, series hybrid powertrain, a parallel hybrid powertrain a range-extending engine-generator system, or a hydrogen fuel cell.

3. The vehicle system of claim 1, wherein the commercial power magnitude is in a range of about 50 kW to about 500 kW.

4. The vehicle system of claim 3, wherein the commercial power magnitude is about 75 kW.

5. The vehicle system of claim 1, wherein the interface comprises at least one cam-style locking connector operable to connect an electrical load to the system and at least one control configured to control the vehicle system.

6. The vehicle system of claim 1, wherein the inverter is any of liquid cooled, convection cooled, or a combination thereof.

7. The vehicle system of claim 1, wherein the system is configured to form an island grid.

8. The vehicle system of claim 1, wherein the interface further comprises a human-machine interface, controls for remote access, safety software, and a safety shutoff.

9. The vehicle system of claim 1, wherein the inverter is disposed proximal to the power source on an underbody of the vehicle.

10. The vehicle system of claim 1, wherein the interface is disposed on a side portion of the vehicle.

11. The vehicle system of claim 1, wherein the vehicle is one of a battery electric vehicle (EV), a hybrid electric vehicle (HEV), a plug-in hybrid electric vehicle (PHEV), a range extended electric vehicle or a hydrogen fuel cell electric vehicle.

12. The vehicle system of claim 1, wherein the vehicle is one of a commercial fleet vehicle, a work vehicle or an industrial vehicle, an off highway vehicle, or a piece of equipment.

13. A method of controlling off-grid power export from a vehicle, comprising:
providing from a DC power source one directional DC power to an inverter in a single direction;
transforming the DC power to AC power via the inverter in a single direction; and
exporting the AC power to a user via an interface;
wherein the providing, transforming, and exporting are controlled via a control unit disposed in the interface.

14. The method of claim 13, wherein the control unit is controlled wirelessly by an operator.

15. The method of claim 13, wherein the DC power is transformed into one of split phase AC power, three-phase AC power, or retained as DC power.

16. The method of claim 13, wherein the AC power is provided at a magnitude of about 75 KW.

17. The method of claim 13, wherein the AC power is not provided to a power grid.

18. The method of claim 13, wherein the power export forms an island grid.

19. The method of claim 13, wherein the control unit is communicatively coupled to both the power source and the inverter.

20. The method of claim 13, wherein the power is exported at 120V/240V residential voltage.
